(19) United States
(12) Patent Application Publication
(10) Pub. No.: US 2018/0089672 A1
(43) Pub. Date: Mar. 29, 2018

(54) Payment Facilitation Device and Payment Facilitation Method

(71) Applicant: MASTERCARD ASIA/PACIFIC PTE. LTD., Singaprore (SG)

(72) Inventors: Ai Ling Felicia Choo, Singapore (SG); Eric Jian Hui Lin, Singapore (SG); Benjamin Charles Gilbey, Singapore (SG)

(21) Appl. No.: 15/708,615

(22) Filed: Sep. 19, 2017

(30) Foreign Application Priority Data
Sep. 28, 2016 (SG) 10201608094U

(51) Int. Cl. G06Q 20/38

(52) U.S. Cl. CPC G06Q 20/3821; G06Q 20/3829

(57) ABSTRACT

A payment facilitation device and a payment facilitation method. The device includes a first transceiver module configured to receive a payment token from an external computing device via a first wireless communications protocol; a second transceiver module configured for wireless communication with a merchant payment device via a second wireless communications protocol that is different from the first wireless communications protocol; and a processor module configured to cause the second transceiver module to transmit the payment token to the merchant payment device upon receipt of a payment request from the merchant payment device.

### CROSS-REFERENCE TO RELATED APPLICATION

This application claims the benefit of and priority to Singapore Patent Application No. 10201608094U filed Sep. 28, 2016. The entire disclosure of the above application is incorporated herein by reference.

### FIELD

The present disclosure relates broadly, but not exclusively, to a payment facilitation device and payment facilitation method.

### BACKGROUND

This section provides background information related to the present disclosure which is not necessarily prior art.

In some countries, tolls are collected for road usage, especially usage of highways and roads in the city centre. In certain countries, tolls are electronically collected instead of having drivers manually pay tolls to an operator at a toll booth.

For example, in Singapore, the Electronic Road Pricing (ERP) system is an electronic toll collection scheme that uses open road tolling in which vehicles do not stop or slow down to pay tolls. The scheme has gantries located at relevant roads, where each gantry has a system of sensors. Each Singapore-registered vehicle has a device known as an In-vehicle Unit (IU), in which a stored-value cash card is inserted for payment of the road usage charges.

When a vehicle equipped with an IU passes under a gantry, a road usage charge is deducted from the stored-value cash card in the IU. Sensors installed on the gantries communicate with the IU via a dedicated short-range communication system. If a vehicle owner does not have sufficient value in their stored-value cash card when passing through a gantry, the owner receives a fine. Sometimes, vehicle owners may forget to reload their stored-value cash card and end up receiving a fine.

In some car parks, a variant of the ERP system is used to electronically collect car park charges. A gantry is located at the exit of the car park. When a vehicle equipped with an IU passes under the gantry, a car park charge is deducted from the stored-value cash card in the IU. Similarly, if a vehicle owner forgets to reload his stored-value cash card and there is insufficient value in the cash card, he is unable to exit the car park unless he inserts a stored-value cash card with sufficient value in his IU.

A need therefore exists to provide methods and/or systems to address at least some of the above problems.

### SUMMARY

This section provides a general summary of the disclosure, and is not a comprehensive disclosure of its full scope or all of its features. Aspects and embodiments of the disclosure are set out in the accompanying claims.

According to a first aspect, there is provided a payment facilitation device, comprising: a first transceiver module configured to receive a payment token from an external computing device via a first wireless communications protocol; a second transceiver module configured for wireless communication with a merchant payment device via a second wireless communications protocol that is different from the first wireless communications protocol; and a processor module configured to cause the second transceiver module to transmit the payment token to the merchant payment device upon receipt of a payment request from the merchant payment device.

The external computing device may be a mobile user device with a digital wallet application installed thereon. The first wireless communications protocol may be Bluetooth® low energy (BLE).

The mobile user device and the payment facilitation device may be configured to exchange a key pair for use in asymmetric cryptography upon pairing between the mobile user device and the payment facilitation device.

The processor module may be further configured to cause the first transceiver module to transmit a payment token request to the mobile user device, and the payment token is received by the first transceiver module from the mobile user device in response to the payment token request.

The payment token may be encrypted based on an asymmetric cryptography technique such that the payment token can only be decrypted by the mobile user device and the payment facilitation device.

The external computing device may be a computer server and the first wireless communications protocol is a wireless mobile telecommunications protocol.

The processor module may be further configured to cause the first transceiver module to transmit a request for pairing to the computer server, and a pairing identity is received by the first transceiver module from the computer server in response to the request for pairing.

The payment facilitation device may further comprise a third transceiver module configured to transmit the pairing identity to a mobile user device via a third wireless communications protocol. The mobile user device may be configured to transmit a request-to-pair to the computer server, and the request-to-pair is associated with the pairing identity.

The payment token may be received by the first transceiver module from the computer server in response to the request-to-pair, and the payment token may be uniquely associated with the mobile user device and the payment facilitation device based on the pairing identity.

The second wireless communications protocol may be a radio-frequency (RF)-based communications protocol.

According to a second aspect, there is provided a payment facilitation method, comprising: receiving, at a payment facilitation device, a payment token from an external computing device via a first wireless communications protocol; and transmitting, from the payment facilitation device, the payment token to a merchant payment device upon receipt of a payment request from the merchant payment device, wherein the payment facilitation device is in wireless communication with the merchant payment device via a second wireless communications protocol that is different from the first wireless communications protocol.

The external computing device may be a mobile user device with a digital wallet application installed thereon. The first wireless communications protocol may be Bluetooth® low energy (BLE).

The method may further comprise exchanging, between the mobile user device and the payment facilitation device, a key pair for use in asymmetric cryptography upon pairing between the mobile user device and the payment facilitation device.

The method may further comprise transmitting, by the payment facilitation device, a payment token request to the mobile user device, wherein the payment token is received at the payment facilitation device from the mobile user device in response to the payment token request.

The method may further comprise encrypting the payment token based on an asymmetric cryptography technique such that the payment token can only be decrypted by the mobile user device and the payment facilitation device.

The external computing device may be a computer server and the first wireless communications protocol may be a wireless mobile telecommunications protocol.

The method may further comprise: transmitting a request for pairing from the payment facilitation device to the computer server; and transmitting a pairing identity from the computer server to the payment facilitation device in response to the request for pairing.

The method may further comprise: transmitting the pairing identity to a mobile user device via a third wireless communications protocol; and transmitting a request-to-pair from the mobile user device to the computer server, wherein the request-to-pair may be associated with the pairing identity.

The method may further comprise receiving, at the payment facilitation device, the payment token from the computer server in response to the request-to-pair, wherein the payment token may be uniquely associated with the mobile user device and the payment facilitation device based on the pairing identity.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments and implementations are provided by way of example only, and will be better understood and readily apparent to one of ordinary skill in the art from the following written description, read in conjunction with the drawings, in which:

FIG. 1 shows a schematic diagram illustrating flow of information between various entities during a payment facilitation method, according to an example implementation;

FIG. 2 shows a schematic diagram illustrating flow of information between various entities during a payment facilitation method, according to another example implementation; and

FIG. 3 is a schematic diagram of a payment facilitation device, according to an example embodiment.

Corresponding reference numerals indicate corresponding parts throughout the several views of the drawings.

### DETAILED DESCRIPTION

Embodiments will be described, by way of example only, with reference to the drawings. The description and specific examples included herein are intended for purposes of illustration only and are not intended to limit the scope of the present disclosure. Again, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the present disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program, when loaded and executed on such a computer, effectively results in an apparatus that implements the steps of the method.

In an embodiment, there is provided a payment facilitation device that comprises a first transceiver module, a second transceiver module and a processor module that is communicably coupled with the transceiver modules. The first transceiver module is configured to receive a payment token from an external computing device via a first wireless communications protocol. The second transceiver module is configured for wireless communication with a merchant payment device via a second wireless communications protocol. The second wireless communications protocol is different from the first wireless communications protocol. The processor module is configured to cause the second transceiver module to transmit the payment token (received by the first transceiver module) to the merchant payment device upon receipt of a payment request from the merchant payment device. The second wireless communications protocol may be a radio-frequency (RF)-based communications protocol.

In one implementation, the external computing device is a mobile user device (e.g., smartphone or tablet computer) with a digital (mobile) wallet application installed thereon. The first wireless communications protocol may be Bluetooth® (e.g., Bluetooth® low energy (BLE)) or a wireless mobile telecommunications protocol (e.g., 3G, 4G). Assuming that the first wireless communications protocol is BLE, the mobile user device and the payment facilitation device are configured to exchange a key pair for use in asymmetric cryptography upon BLE pairing between the mobile user device and the payment facilitation device.

The processor module is further configured to cause the first transceiver module to transmit a payment token request to the mobile user device. The payment token is received by the first transceiver module from the mobile user device in response to the payment token request.

For security, the payment token may be encrypted based on an asymmetric cryptography technique so that the payment token can only be decrypted by the mobile user device and the payment facilitation device.

In alternative implementation, the external computing device is a computer server and the first wireless communications protocol is a wireless mobile telecommunications protocol (e.g., 3G, 4G). The computer server may be administered by a merchant (e.g., owner of car park, or a government in the case of a public road). The processor module may be further configured to cause the first transceiver module to transmit a request for pairing to the computer server, and a pairing identity is received by the first transceiver module from the computer server in response to the request for pairing.

In this alternative implementation, the payment facilitation device may further comprise a third transceiver module configured to transmit the pairing identity to a mobile user device (e.g., smartphone or tablet computer) via a third wireless communications protocol (e.g., Bluetooth® low energy (BLE)). The mobile user device is configured to transmit a request-to-pair to the computer server, and the request-to-pair is associated with the pairing identity.

In this alternative implementation, the payment token is received by the first transceiver module from the computer server in response to the request-to-pair. The payment token is uniquely associated with the mobile user device and the payment facilitation device based on the pairing identity.

With reference to the prior art Electronic Road Pricing (ERP) system described above, the merchant payment device of both implementations can be disposed at each gantry to supplement or replace the sensors. The merchant payment device is able to communicate with the payment facilitation device (which now acts as the IU) via a dedicated short-range communication system, such a radio-frequency (RF)-based communications protocol.

Instead of requiring users to insert a stored-value cash card into the IU for payment of the road usage charges, as per the prior art, embodiments of the present disclosure use payment tokens for payment of the road usage charges via the payment facilitation device. For example, in the first implementation, the digital wallet application installed in the mobile user device may be used to request payment tokens from a payment service provider. The payment service provider provides payment tokens to the user at the mobile user device. The mobile user device in turn sends the payment tokens to the payment facilitation device (i.e., the “IU”). When a vehicle equipped with the payment facilitation device passes under a gantry with the merchant payment device, the payment token is used to pay the road usage charge (rather than deducting the road usage charge from the stored-value cash card in the IU, as per prior art). In this manner, the mobile user device becomes a unique identifier of the vehicle, and acts as a second IU (or a proxy for the original IU). Advantageously, the vehicle owner does not need to constantly monitor the value in the stored-value cash card and reload the stored-value cash card once the value is depleted. The payment token is associated with a user's account (e.g., credit card account) that can be managed using the digital wallet application. Any payment (e.g., road toll or car-park charges) can be deducted from the user's account by utilization of the payment token. As the payment token is unique to a particular mobile user device and particular payment facilitation device, any payment card that is loaded in the digital wallet application is able to facilitate the payment process.

In an embodiment, there is provided a payment facilitation method, comprising a first step of receiving, at a payment facilitation device, a payment token from an external computing device via a first wireless communications protocol, and a second step of transmitting, from the payment facilitation device, the payment token to a merchant payment device upon receipt of a payment request from the merchant payment device. The payment facilitation device is in wireless communication with the merchant payment device via a second wireless communications protocol that is different from the first wireless communications protocol. The second wireless communications protocol may be a radio-frequency (RF)-based communications protocol.

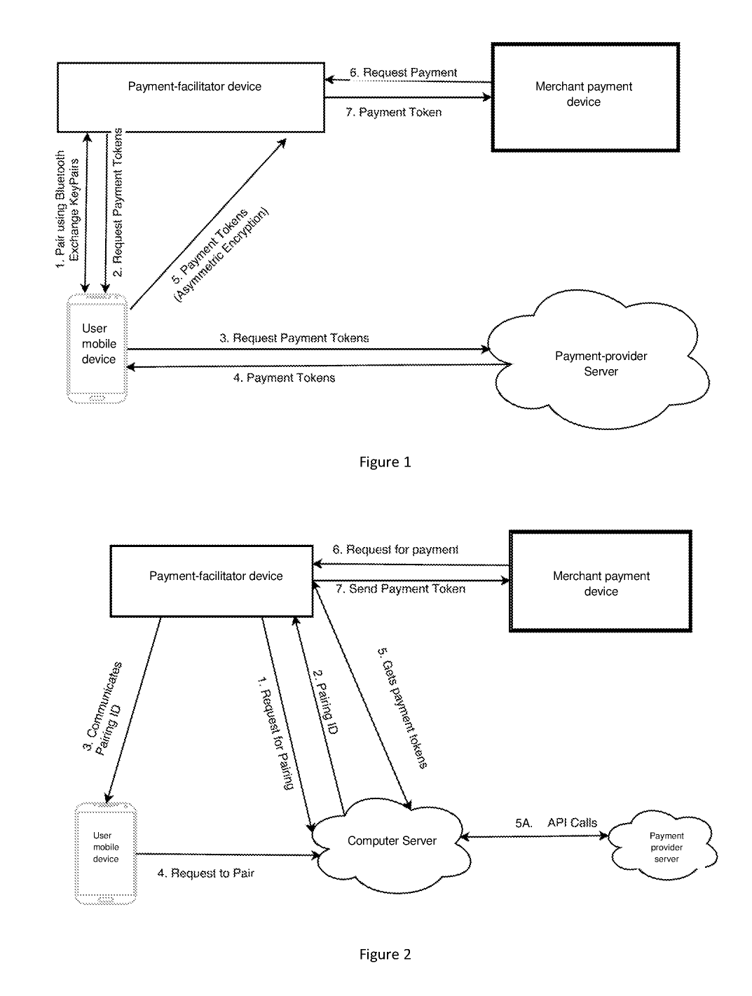

FIG. 1 shows a schematic diagram illustrating flow of information between various entities during a payment facilitation method, according to an example implementation. In this implementation, the external computing device is a mobile user device (e.g., smartphone or tablet computer) with a digital wallet application installed thereon and the first wireless communications protocol is Bluetooth® (e.g., Bluetooth® low energy (BLE)).

Assuming the first wireless communications protocol is BLE, a first step involves pairing the mobile user device and the payment facilitation device via BLE. After pairing, a key pair for use in asymmetric cryptography is exchanged between the mobile user device and the payment facilitation device.

A second step involves transmitting a payment token request from the payment facilitation device to the mobile user device. Thereafter, at a third step, the mobile user device relays the payment token request from the payment facilitation device to a payment provider server. At a fourth step, in response to the payment token request, the payment provider server sends a payment token to the mobile user device.

At a fifth step, the user device transmits the payment token to the payment facilitation device. In other words, the payment token is received at the payment facilitation device from the mobile user device in response to the payment token request.

For security, the method may further include the step of encrypting the payment token based on an asymmetric cryptography technique such that the payment token can only be decrypted by the mobile user device and the payment facilitation device.

At a sixth step, a payment request is sent from the merchant payment device to the payment facilitation device. For example, when a vehicle equipped with the payment facilitation device passes under a gantry with the merchant payment device, the merchant payment device sends a payment request to the payment facilitation device, e.g., for payment of a road toll or car-park charge. At a seventh step, the payment token is transmitted to the merchant payment device so that payment can be made to the merchant. Therefore, when a vehicle equipped with the payment facilitation device passes under a gantry with the merchant payment device, the payment token is used to pay the road usage charge (rather than deducting the road usage charge from the stored-value cash card in the IU, as per prior art).

FIG. 2 shows a schematic diagram illustrating flow of information between various entities during a payment facilitation method, according to an alternative example implementation. In this alternative implementation, the external computing device is a computer server and the first wireless communications protocol is a wireless mobile telecommunications protocol (e.g., 3G, 4G). The computer server may be administered by a merchant (e.g., owner of car park, or a government in the case of a public road).

A first step of the method involves transmitting a request for pairing from the payment facilitation device to the computer server. At a second step, in response to the request for pairing, a pairing identity is transmitted from the computer server to the payment facilitation device.

At a third step, the pairing identity is transmitted from the payment facilitation device to a mobile user device (e.g., smartphone or tablet computer) via a third wireless communications protocol (e.g., Bluetooth® low energy (BLE)). A fourth step involves transmitting a request-to-pair from the mobile user device to the computer server. The request-to-pair is associated with the pairing identity. It should be noted that the “request for pairing” in the first step is different from the “request-to-pair” in the fourth step. The “request for pairing” is an initial request and seeks a unique pairing identity for subsequent pairing between the payment facilitation device and the mobile user device.

A fifth step involves the payment facilitation device transmitting a payment token request to the computer server. If appropriate, the computer server may request for payment tokens from a payment provider server or a token service provider via a suitable API call, as shown at step 5A. For example, a payment provider (e.g., MasterCard®) may administer the payment provider server and the merchant's computer server makes a mobile wallet (e.g., MasterPass®) API call to the payment provider server in order to obtain a payment token. The computer server sends the payment token to the payment facilitation device in response to the payment token request to complete the fifth step. In other words, the payment facilitation device receives the payment token from the computer server in response (albeit indirectly) to the request-to-pair of the fourth step. The payment token is uniquely associated with the mobile user device and the payment facilitation device based on the pairing identity.

At a sixth step, a payment request is sent from the merchant payment device to the payment facilitation device. For example, when a vehicle equipped with the payment facilitation device passes under a gantry with the merchant payment device, the merchant payment device sends a payment request to the payment facilitation device, e.g., for payment of a road toll or car-park charge. At a seventh step, the payment token is transmitted to the merchant payment device so that payment can be made to the merchant. Therefore, when a vehicle equipped with the payment facilitation device passes under a gantry with the merchant payment device, the payment token is used to pay the road usage charge (rather than deducting the road usage charge from the stored-value cash card in the IU, as per prior art).

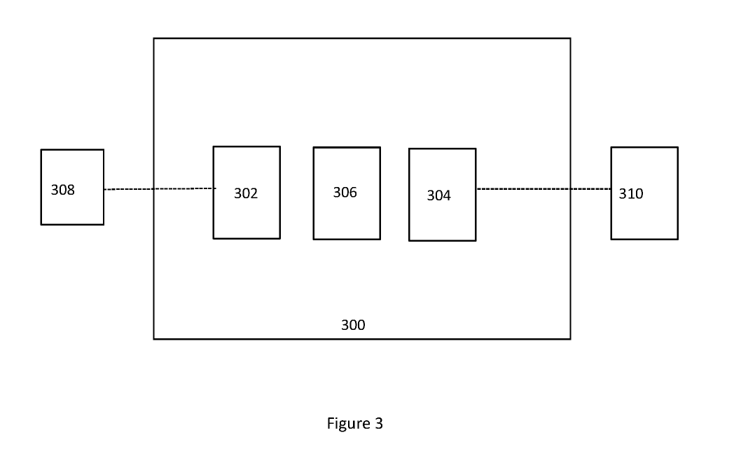

FIG. 3 is a schematic of a payment facilitation device 300, according to an example embodiment. The payment facilitation device 300 includes a first transceiver module 302 configured to receive a payment token from an external computing device 308 via a first wireless communications protocol. The payment facilitation device 300 also includes a second transceiver module 304 configured for wireless communication with a merchant payment device 310 via a second wireless communications protocol that is different from the first wireless communications protocol. The payment facilitation device 300 further includes a processor module 306 configured to cause the second transceiver module 304 to transmit the payment token to the merchant payment device 310 upon receipt of a payment request from the merchant payment device 310. The second wireless communications protocol may be a radio-frequency (RF)-based communications protocol.

In one implementation, the external computing device 308 is a mobile user device with a digital wallet application installed thereon. The first wireless communications protocol is Bluetooth® low energy (BLE). The mobile user device and the payment facilitation device 300 are configured to exchange a key pair for use in asymmetric cryptography upon pairing between the mobile user device and the payment facilitation device 300.

The processor module 306 is further configured to cause the first transceiver module 302 to transmit a payment token request to the mobile user device, and the payment token is received by the first transceiver module 302 from the mobile user device in response to the payment token request. The payment token is preferably encrypted based on an asymmetric cryptography technique such that the payment token can only be decrypted by the mobile user device and the payment facilitation device 300.

In another implementation, the external computing device 308 is a computer server and the first wireless communications protocol is a wireless mobile telecommunications protocol.

The processor module 306 is further configured to cause the first transceiver module 302 to transmit a request for pairing to the computer server, and a pairing identity is received by the first transceiver module 302 from the computer server in response to the request for pairing.

The payment facilitation device 300 may further include a third transceiver module (not shown in FIG. 3) that is configured to transmit the pairing identity to a mobile user device via a third wireless communications protocol. The mobile user device is configured to transmit a request-to-pair to the computer server, and the request-to-pair is associated with the pairing identity.

The payment token is received by the first transceiver module 302 from the computer server in response to the request-to-pair, and the payment token is uniquely associated with the mobile user device and the payment facilitation device 300 based on the pairing identity.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A payment facilitation device, comprising:
a first transceiver module configured to receive a payment token from an external computing device via a first wireless communications protocol;
a second transceiver module configured for wireless communication with a merchant payment device via a second wireless communications protocol that is different from the first wireless communications protocol; and
a processor module configured to cause the second transceiver module to transmit the payment token to the merchant payment device upon receipt of a payment request from the merchant payment device.

2. The payment facilitation device as claimed in claim 1, wherein the external computing device is a mobile user device with a digital wallet application installed thereon.

3. The payment facilitation device as claimed in claim 2, wherein the first wireless communications protocol is Bluetooth® low energy (BLE); and/or
wherein the second wireless communications protocol is a radio-frequency (RF)-based communications protocol.

4. The payment facilitation device as claimed in claim 2, wherein the mobile user device and the payment facilitation device are configured to exchange a key pair for use in asymmetric cryptography upon pairing between the mobile user device and the payment facilitation device.

5. The payment facilitation device as claimed in claim 4, wherein the processor module is further configured to cause the first transceiver module to transmit a payment token request to the mobile user device, and wherein the payment token is received by the first transceiver module from the mobile user device in response to the payment token request.

6. The payment facilitation device as claimed in claim 4, wherein the payment token is encrypted based on an asymmetric cryptography technique such that the payment token can only be decrypted by the mobile user device and the payment facilitation device.

7. The payment facilitation device as claimed in claim 1, wherein the external computing device is a computer server and the first wireless communications protocol is a wireless mobile telecommunications protocol.

8. The payment facilitation device as claimed in claim 7, wherein the processor module is further configured to cause the first transceiver module to transmit a request for pairing to the computer server, and wherein a pairing identity is received by the first transceiver module from the computer server in response to the request for pairing.

9. The payment facilitation device as claimed in claim 8, further comprising a third transceiver module configured to transmit the pairing identity to a mobile user device via a third wireless communications protocol, wherein the mobile user device is configured to transmit a request-to-pair to the computer server, wherein the request-to-pair is associated with the pairing identity.

10. The payment facilitation device as claimed in claim 9, wherein the payment token is received by the first transceiver module from the computer server in response to the request-to-pair, and wherein the payment token is uniquely associated with the mobile user device and the payment facilitation device based on the pairing identity.

11. (canceled)

12. A payment facilitation method, comprising:
receiving, at a payment facilitation device, a payment token from an external computing device via a first wireless communications protocol; and
transmitting, from the payment facilitation device, the payment token to a merchant payment device upon receipt of a payment request from the merchant payment device, wherein the payment facilitation device is in wireless communication with the merchant payment device via a second wireless communications protocol that is different from the first wireless communications protocol.

13. The payment facilitation method as claimed in claim 12, wherein the external computing device is a mobile user device with a digital wallet application installed thereon.

14. The payment facilitation method as claimed in claim 13, wherein the first wireless communications protocol is Bluetooth® low energy (BLE); and/or
wherein the second wireless communications protocol is a radio-frequency (RF)-based communications protocol.

15. The payment facilitation method as claimed in claim 13, further comprising exchanging, between the mobile user device and the payment facilitation device, a key pair for use in asymmetric cryptography upon pairing between the mobile user device and the payment facilitation device.

16. The payment facilitation method as claimed in claim 15, further comprising transmitting, by the payment facilitation device, a payment token request to the mobile user device, wherein the payment token is received at the payment facilitation device from the mobile user device in response to the payment token request.

17. The payment facilitation method as claimed in claim 15, further comprising encrypting the payment token based on an asymmetric cryptography technique such that the payment token can only be decrypted by the mobile user device and the payment facilitation device.

18. The payment facilitation method as claimed in claim 12, wherein the external computing device is a computer server and the first wireless communications protocol is a wireless mobile telecommunications protocol.

19. The payment facilitation method as claimed in claim 18, further comprising:
transmitting a request for pairing from the payment facilitation device to the computer server; and
transmitting a pairing identity from the computer server to the payment facilitation device in response to the request for pairing.

20. The payment facilitation method as claimed in claim 19, further comprising:
transmitting the pairing identity to a mobile user device via a third wireless communications protocol; and
transmitting a request-to-pair from the mobile user device to the computer server, wherein the request-to-pair is associated with the pairing identity.

21. The payment facilitation method as claimed in claim 20, further comprising receiving, at the payment facilitation device, the payment token from the computer server in response to the request-to-pair, wherein the payment token is uniquely associated with the mobile user device and the payment facilitation device based on the pairing identity.

22. (canceled)
